(19) United States
(12) Patent Application Publication
(10) Pub. No.: US 2014/0274386 A1
(43) Pub. Date: Sep. 18, 2014

(54) PEER-SCORED COMMUNICATION IN ONLINE ENVIRONMENTS

(71) Applicants: Marilyn M. Ault, Topeka, KS (US); Jana Craig Hare, Baldwin City, KS (US); Dave Scherrer, Shawnee, KS (US); Jason Kroge, Overland Park, KS (US); Isa Kretschmer, Lawrence, KS (US); Phuong Tran, Lawrence, KS (US); Doug Adams, Mission, KS (US); Janis Bulgren, Lawrence, KS (US)

(72) Inventors: Marilyn M. Ault, Topeka, KS (US); Jana Craig Hare, Baldwin City, KS (US); Dave Scherrer, Shawnee, KS (US); Jason Kroge, Overland Park, KS (US); Isa Kretschmer, Lawrence, KS (US); Phuong Tran, Lawrence, KS (US); Doug Adams, Mission, KS (US); Janis Bulgren, Lawrence, KS (US)

(73) Assignee: UNIVERSITY OF KANSAS, Lawrence, KS (US)

(21) Appl. No.: 14/216,245

(22) Filed: Mar. 17, 2014

Related U.S. Application Data
(60) Provisional application No. 61/794,693, filed on Mar. 15, 2013.

(51) Int. Cl. A63F 13/30

(52) U.S. Cl. CPC A63F 13/12
USPC 463/31

(57) ABSTRACT

Systems and methods for peer-scored dialogue are provided. Meaningful communications are fostered by enabling students or players of an online game to affect the score of other players by scoring the communications of other players.

### CROSS-REFERENCE TO RELATED APPLICATIONS

This application claims the benefit of U.S. Provisional Application Ser. No. 61/794,693 filed Mar. 15, 2013 and entitled PEER-SCORED COMMUNICATION IN ONLINE ENVIRONMENTS, which application is incorporated by reference in its entirety.

### BACKGROUND OF THE INVENTION

1. The Field of the Invention

Embodiments of the present invention relate to communicating in an online environment. More particularly, embodiments of the invention relate to systems and methods for enabling users to self-moderate communications in an online environment such as a multi-player online game.

2. The Relevant Technology

Advances in technology are increasingly being integrated into many different activities including education. For example, many subjects taught in nearly all schools have an online component, including the use of online chat or text-based environments to support discourses. Class schedules, class syllabus, homework assignments, and the like are now available online. To further the educational experience, educational online games have been developed. Allowing students to participate in online educational games can enhance the learning experience. This is particularly true as the new educational standards, particularly in mathematics, science, language arts, and civics, include dialogue and argumentation as key skills to develop across all grades.

Educational games have been developed that aim to develop skills. Many of these educational games are online multi-player games. Many developers recognize the power of incorporating a chat-component in online games to engage the participants. Unfortunately, chat functions have proven problematic to the learning experience. In fact, the discussion that emerges in the chat function is often unrelated to the educational target of the game. Often the chat that occurs within the game is inconsequential, off target, or inappropriate. To complicate the problem, teachers are unable to monitor ongoing-chat as students play online competitive games, particularly if the play occurs outside of the instructional day. As a result, a potentially engaging and instructive game feature is generally not available in educational games. Systems and methods are needed to enable communication in online environments including multi-player online educational games.

### BRIEF DESCRIPTION OF THE DRAWINGS

In order to describe the manner in which the above-recited and other advantages and features of embodiments of the invention can be obtained, a more particular description of embodiments of the invention will be rendered by reference to specific embodiments thereof which are illustrated in the appended drawings. Understanding that these drawings depict only typical embodiments of the invention and are not therefore to be considered to be limiting of its scope, embodiments of the invention will be described and explained with additional specificity and detail through the use of the accompanying drawings in which:

FIG. 1 illustrates a part of an online game where a player is asked to enter rationale statement related to a claim and illustrates a user interface for testing a player or student;

FIG. 2 illustrates shows game-play after responding to the claims and engaging in the race;

FIG. 3 illustrates a user interface presented to the player or student that includes results and a discussion area where the player is able to enter is discourse and score communications made by other players;

FIG. 4 illustrates a user interface for use by a teacher or facilitator showing a players' activity during each component of the game and the online communication;

FIG. 5 illustrates a user interface for use by a teacher or facilitator that shows all conversation between all players in each communication; and

FIG. 6 is a flow diagram illustrating a process of fostering discussion in an online educational game.

### DETAILED DESCRIPTION OF THE PREFERRED EMBODIMENTS

Embodiments of the invention relate to systems and methods for fostering discussion in an online environment. More particularly, embodiments of the invention relate to systems and methods for encouraging constructive communications (e.g., text-based chat communications) in an online educational or instructional game.

Embodiments of the invention foster meaningful communications such as chats or texts by allowing the players to give scores to the communications of others. By scoring the communications of other players in the online environment (e.g., the online game), the outcome of the activity or game can be affected. The following discussion focuses on online games, but embodiments extend to other online environments that allow participants to communication via text, video, chat, audio, or the like or combination thereof.

The participants of the online game are referred to as participants or players, but the players may be examples of students and the online game may also be associated with a teacher of the students or players. Other online environments that incorporate embodiments of the invention may include similar relationships (e.g., member-supervisor, employee-manager).

Embodiments of the invention configure the communications to produce a socially mediating event. Competitive players are able to increase or decrease the score of other players by scoring the communications (e.g., text-based chat) of other players. In addition, all players and a teacher have access to all of the communications in one example. Over time or as more sessions of the online education game are played, players will learn that to acquire more points in the game, their communications within the context of the educational game should be substantive and informative to other players. Players have the ability to down-score inappropriate or frivolous comments. The teacher can ensure, in one example, that comments are not scored inappropriately or unfairly. For example, a teacher can prevent a substantive and informative communication from being negatively scored. Together, these factors socially mediate the players such that learning is improved.

The ability to score communications of other players is an example of peer-scored dialog. The online game can be configured such that communications occurring within the game or within the context of the game associated with learning a particular skill, set of skills, or to achieve a certain object. An online game can be designed, for example, to enhance skills associated with scientific argumentation. Embodiments of the invention can socially mediate communications within the online game such that players or students have the opportunity to constructively practice the skills associated with scientific argumentation.

In one example, during the course of the game, a player may be presented with a question or claim (e.g., via text, audio and/or video) or with another interface that requires the player to provide input (using one or more types of input such as keyboard, mouse, gesture, camera, microphone, or the like or combination thereof).

FIG. 1 illustrates an example of a user interface 100 that may be presented to a player during gameplay. The online game discussed with respect to FIG. 1 may be configured to strengthening skills associated with scientific argumentation. One of skill in the art, with the benefit of the present disclosure, can appreciate that the arrangement of the user interface can vary and may depend on the skill being taught, the object of the game, the purpose of the online environment, or the like. In each case, however, the communications that occur in the context of the game enable users to self-mediate.

During the course of the game, a user (or player) may reach a stop point 116. The game may include multiple stop points 116. During a stop point 116, the user or player may be provided with an instruction 114 (or question, statement, etc.), which is illustrated in the user interface 100. In this example, the instruction 114 instructs a user to read a claim 112 and a passage of text 102. After reading the claim 112 and the text 102, the user interface 100 is configured to receive input from a user. The input may include a response 104 (e.g., entered using radio boxes) or other user interface element. In this example, the user is asked to accept, reject, or withhold judgment on the claims 112. The input may also include a rationale 106, which may be entered in a text box, to justify the response 104.

An accept element 110 enables a user to submit the response 104 and the rationale 106. The user interface 100 may also illustrate the player's progress in the game in area 108.

FIG. 2 illustrates an example of gameplay 200 in the user interface 100. The gameplay may be separate from the skills being taught in terms of context. For example, an online race car game is unrelated to the skill of scientific argumentation. However, the communications that occur within the game and the ability of players to impact the overall score of other players by scoring the communications of others ensures that the communications become an integral part of the game. The ability to achieve a high score, for example, may depend on the way that a particular player's communications are scored by the other players.

FIG. 2 thus illustrates the gameplay 200 that may occur after the stop point 116. As previously stated, the game may include multiple stop points. The progress of the player may be illustrated in the area 108. The arrangement of the stop points 116 with respect to the gameplay can vary. In one example, the progress of the player is not displayed, although this may depend on the gameplay.

One of skill in the art can appreciate that the gameplay and corresponding user interface may vary greatly. Stated another way, the online environment may be presented in different ways and may an online game. When the online environment is an online game, the gameplay may be two-dimensional, three-dimensional, single player, level based, or the like. In one example, however, the gameplay includes the stop points 116 such that the purpose associated with the gameplay (e.g., foster learning and communication in one example) can be achieved.

FIG. 3 illustrates a user interface 300 where the player can view his or her own communications as well as the communications of other players. The user interface 300 also receives input from the player that scores the communications of the other players.

The user interface 300 illustrates an example of peer-scoring where input from a user is used to score the other players or to impact a score of the other players.

The user interface 300 illustrates players 302, 304, 306, 308, and 310. The user interface also illustrates the response 312 and rationale 314 for the player 302. The response and the rationale of other players is also displayed in the user interface 300. A discussion of the response 312 and the rationale 314 applies equally to the response and rationale of the other players in the multi-player online game.

The score area 332 is associated with the response 312 and the rationale 314. The score area 332 reflects how other players 334 may have scored the response 312 and/or the rationale 314. In this example, the player 302 received several positive scores and no negative scores. In contrast, the rational 336 of the player 310 receives a negative score in the score area 338 because of the rationale 336 is frivolous. The score area 338 reflects the scoring of the players 302, 304, 306, and 308.

Because the player 302 receive a positive score in the score area 332, the player is likely encouraged to continue to provide responses that rationale that are in line with the objective of the game to strengthen the player's skill. The player 310 may be similarly motivated to communicate in a non-frivolous manner in order to achieve a positive score in the score area 338. The communications of the players will likely improve as the game is played more times due to the influence of the scoring performed by other players. In other words, the peer-scored dialogue (e.g., the response and/or rationale of each player is scored by the other players) can mediate, by way of example only, future responses and/or rationales. Learning can be improved as well.

The user interface 300 also illustrates communications 316, 318, 320, and 322 of at least some of the other players 334 with respect to the response 312 and/or rationale 314 of the player 302. These communications (which are examples of text-based chat that occurred during gameplay and/or after gameplay) can also be scored by the other players. More specifically, communications by the player 302 can be scored by the players 334. Communications by the player 304, similarly, can be scored by the players 302, 306, 308, and 310 or other players.

The communications 316, 318, 320, and 322 are associated with, respectively, score areas 324, 326, 328, and 330. The score areas reflect how the communications were scored by the other players.

In FIG. 3, the scoring is performed by giving a thumbs up, a thumbs down, or no response. Other scoring mechanisms can also be employed (e.g., stars, rating in a predetermined range). As a result, the peer scored dialogue or communications 312, 314, 316, 318, 320, and 322 can increase a player's score, decrease a player's score, or leave a player's score unchanged. The input used to score the communications of other players can occur in different screens and at different points of the gameplay. The players can provide input when a communication is displayed during gameplay, after the game when the players have an opportunity to review all of the communications, or the like. The user interface 300 can be configured to display the communications in different ways and methods. A tab may be used for each player and the screen of each tab may display communications associated with the selected player. Alternatively, the communications can be displayed as conversations. The communications can be displayed in other manners as well. A player can score another player's communication at any time during gameplay or after gameplay. The game may, however, place a limit on the time during which scoring can occur. The players may score other communications of other players in the user interface 300.

FIG. 4 illustrates a user interface showing results for the players in the online game. The user interface 400 is typically available to a teacher of the players and enables a teacher to evaluate the progress of the players or students as well as understand how well students are acquiring the skill that is the intended object of the online game, for example. The user interface 400 enables a report on each player's activity to be displayed. For example, a report 402 of a player 412 (in a list of students 418) is displayed. The report 402 may include, by way of example only and not limitation, a result or score 410 of the online educational game, a first discussion tally 408 that identifies how many likes or thumbs up were given by the player 412 and how many likes or thumbs up were received by the player 412. The report 402 may include a second discussion tally 406 illustrating how may dislikes or thumbs down were given by the player 412 and how many dislikes or thumbs down were received by the player 412. The report 402 may also include a third discussion tally 404 illustrating how many communications (discussion comments) were given/received by the player 412.

The interface 400 further illustrates the most liked communications 414 and the least liked comments 416. The interface 400 may also include a link to 418 to each student's communications. The user interface may be used to present statistics of the game that are related to the communications. A teacher, for example, can use these metrics to evaluate the communications as a whole or to evaluate the progress of individual players (students).

FIG. 5 is a user interface illustrating an example of a conversation that includes multiple conversations. The user interface 500 is also usually displayed to a teacher. The conversations of more than one player may be displayed in a display 502. The user interface 500 illustrates a display 502 that may identify a player and display one or more of: the player's response 504 and rationale 506 (e.g., response 312 and rationale 314), and communications 508 from the player and/or other players. The display 502 enables a conversation to be followed and may allow, by way of example, a teacher to evaluate the skill of the various players. The display 502 may illustrate a chronological discussion between the author of a comment (e.g., one of the players) and the communications of other players with respect to that comment.

FIG. 6 is a flow diagram illustrating the gameplay of an online game whose objective is to teach a skill to the participants of the online game using at least peer-modified chat, which is an example of communications.

FIG. 6 may begin at some point of the gameplay by testing a player in box 602 or presenting a claim, statement, or other data or information to the player. A user can be tested at a stop point by providing a user interface such as the user interface 100. A claim is presented to the player in box 604 and the claim is read by the user. In box 606, input is received from the player. The input corresponds to a response of the player whereby the claim is rejected, accepted, or judgment is withheld. In box 608, input is received reflecting a rationale for the user's response in box 606.

The method 600 then moves to a results or discussion where results are displayed. In FIG. 6, a placing may be displayed to the player in box 612, points are displayed to the player in box 614, and a claim is displayed to the player in box 618. This information may or may not be displayed to other players.

In the user interface of the results/discussion, the rationale or justifications (or other communications) of other players (e.g., classmates) are presented or displayed to the player in box 620. Input is then received that reflects whether the player evaluating the rationale (or justification or other communication) likes the rationale in box 624 or whether the player dislikes the rational in box 626. Input may also be received in box 622. In box 622, the player may generate a communication that relates to the rationale or justification of one of the other players.

In the box 628, the comments associated with one of the player's rationale is displayed to the player. The player can then like or rate the comment in box 630 or dislike or rate the comment in the box 634. In the box 634, the player may input another communication that is a comment on a comment.

In this manner, the player is first tested on a claim and given an opportunity to generate a rationale or justification for his or her decision regarding a claim. This information may be presented to the player and/or to other players. After the player has entered his or her rationale and at some point of the game (e.g., at the end), the player then has an opportunity to conduct a peer review of other communications that were generated during the gameplay. The peer review occurs when the player views and scores the rationales or justifications of other players, views and scores comments made by the other players or the like with the other players perform similar actions. In this sense, the peer-scored dialogue can be generated.

In box 636, a teacher or other person may view results of the gameplay. The teacher can view the communications (the comments, rationales, justifications, responses, etc.) in different manners. The communications can be viewed by student, by conversation, or the like. A report may also be generated that reflects how a given player scored other players and how other players scored the given player.

FIG. 6, in one example, illustrates a two-stage dialogue process at the end of the online game or at other point of the online game. The last stop point in this example challenges each of the players to read a passage of text and its' claim, then decide to accept, reject, or withhold judgment on the claim. The player then enters his or her rationale in the text box and finishes the online game. The next screen or user interface provides the player with the race time for all the players, but also populates a discussion area, showing his or her communications as well as communications from other players.

The results area (e.g., the user interface 300) allows access to each player's or student's ongoing communications about his or her response to the claim and a record of the scores provided by the other players in the game. Each chat may represent a chronological discussion between the author of the comment and the other players in the game.

Players may have multiple opportunities to have their peers (the other players) score their comments or to score the comments or communications of their peers. Each player can continue commenting within his or her own chat, or in another player's chat, until the game time has ended (e.g., as determined by the teacher) which may be after the game portion has ended. A player can also score any other player's comments in any chat until game time has ended.

Peer-scoring occurs when a player gives, in one example, either a “thumb up” or “thumb down” to any comment or communication provided by another player. After providing a score, players can enter a comment explaining their score. This comment is also available for scoring by other players. A “thumb up” given to a comment adds a point, in one example to the author's total score and a “thumb down” subtracts a point from the author's total score in one example. A player can only score individual comments one time.

Embodiments of the invention relate to a peer-scored dialogue strategy that can moderate frivolous communications and shape a discussion in accordance with a design on an online environment such as an educational game. Over many sessions of play and/or with instruction from a teacher, players will learn that to acquire more points in the game, their rationales and communications should be substantive and informative to other players. Players have the ability to down-score inappropriate or frivolous comments. Players also know that all players and the teacher have access to all communications. Embodiments of the invention thus enable a socially mediating event where players in an online game self-moderate communications such that the communications are relevant and substantive. The occurrence of frivolous or inappropriate comments should reduce over time and as more sessions of the game are played.

The user interfaces may be displayed on a computing device and the computing devices (e.g., laptop computer, desktop computer, tablet device, smartphone, etc.) may interact with a server computing device. The server computing device may operate the game coordinate operation of the game with the computing devices used by the players.

The embodiments described herein may include the use of a special purpose or general-purpose computer including various computer hardware or software modules, as discussed in greater detail below. The servers such as the backup server, the backup file server and other applications may include computing devices or special purpose computing devices.

Embodiments within the scope of the present invention also include computer-readable media for carrying or having computer-executable instructions or data structures stored thereon. Such computer-readable media can be any available media that can be accessed by a general purpose or special purpose computer. By way of example, and not limitation, such computer-readable media can comprise RAM, ROM, EEPROM, CD-ROM or other optical disk storage, magnetic disk storage or other magnetic storage devices, or any other medium which can be used to carry or store desired program code means in the form of computer-executable instructions or data structures and which can be accessed by a general purpose or special purpose computer. Combinations of the above should also be included within the scope of computer-readable media.

Computer-executable instructions comprise, for example, instructions and data which cause a general purpose computer, special purpose computer, or special purpose processing device to perform a certain function or group of functions. Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

As used herein, the term “module” or “component” can refer to software objects or routines that execute on the computing system. The different components, modules, engines, and services described herein may be implemented as objects or processes that execute on the computing system (e.g., as separate threads). While the system and methods described herein are preferably implemented in software, implementations in hardware or a combination of software and hardware are also possible and contemplated. In this description, a “computing entity” may be any computing system as previously defined herein, or any module or combination of modulates running on a computing system.

Embodiments of the present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

What is claimed is:

1. A method for communicating in an online environment to achieve an objective, the method comprising:
requesting input from participants in the online environment by displaying a claim to each of the participants via user interfaces displayed to the participants;
receiving input to the claim from each of the participants, wherein the input received from each participant includes a communication;
displaying the communications of all participants to all participants, wherein each participant receives the communications in their user interface;
receiving input from at least some of the participants via the user interfaces such that each participant is able to provide a score for the communications of the other participants.

2. The method of claim 1, wherein the online environment includes an online game, the method further comprising displaying results of the online game, wherein the results of each of the players includes the scores given to the communications.

3. The method of claim 1, wherein requesting input from participants in the online environment includes presenting each participant with a user interface that includes an area for a rationale of the participant and an area for a response of the participant to a claim.

4. The method of claim 3, wherein the online environment includes one or more stop points, wherein requesting input from the participants in the online environment includes testing the participants at each of the one or more stop points.

5. The method of claim 1, further comprising displaying the communications to a teacher in a user interface associated with the teacher.

6. The method of claim 5, further comprising organizing the communications by at least one of participant, thread, or score.

7. The method of claim 1, further comprising presenting the user interface such that each participant can score any communication made by any of the other participants.

8. The method of claim 1, further comprising changing a score of a communication by the teacher.

9. The method of claim 1, further comprising achieving the objective when the communications are moderated by the scores provided by the participants to the communications.

10. A method for achieving an objective in an online game using communications in the online game, the method comprising:
presenting each player in the online game with a claim related to the objective in a user interface displayed on a player's device;
receiving communications from each player in the online game related to the claim; and
allowing each player to score the communications of other players, wherein a score of each player is increased or decreased according to the communications from the other players.

11. The method of claim 10, wherein the communications are generated during the online game or after the online game.

12. The method of claim 10, further comprising, wherein allowing each player to score the communications of other players causes the communications to be moderated and more related to the objective.

13. The method of claim 10, wherein the communications are peer-scored and impact a final score of each player, wherein communications made by each player, scores provided by each player, and scores received by each player impact the final score of each player.

14. The method of claim 10, wherein allowing each player to score the communications of other players generates communications that are self-moderated by the players.

15. The method of claim 10, wherein the online game includes stop points, wherein the stop points are configured to elicit communications from the players.

16. The method of claim 10, further comprising providing results to a teacher.

17. A method for achieving an objecting in an online environment using peer-scored communications, the method comprising:
displaying a claim to a first participant;
receiving input from the participant relating to the claim, wherein the input includes a communication;
displaying the communication to other participants;
displaying the communications of the other participants to the first participant;
receiving a rating from at least some of the other participants regarding the communication of the first participant;
receiving a rating from the first participant for at least some of the communications of the other participants; and
providing results to a third party.

18. The method of claim 17, further comprising displaying the results to the third party, wherein the results include scores for all of the participants and wherein the results can be sorted at least according to rating, participant, communication, or related communications.

19. The method of claim 17, wherein the communications are received during stop points of the online environment or after the online environment has ended.

20. The method of claim 19, wherein the online environment includes an online game and wherein a gameplay is independent of the objective of the claim, wherein more than one claim is provided to each participant.
